(19) United States
(12) Patent Application Publication
(10) Pub. No.: US 2015/0046797 A1
(43) Pub. Date: Feb. 12, 2015

(54) DOCUMENT FORMAT PROCESSING APPARATUS AND DOCUMENT FORMAT PROCESSING METHOD

(71) Applicants: PEKING UNIVERSITY FOUNDER GROUP CO., LTD., Beijing (CN); FOUNDER APABI TECHNOLOGY LIMITED, Beijing (CN); FOUNDER INFORMATION INDUSTRY HOLDINGS CO., LTD., Beijing (CN)

(72) Inventors: Yun LI, Beijing (CN); Li Ding, Beijing (CN); Qi Bian, Beijing (CN)

(73) Assignees: PEKING UNIVERSITY FOUNDER GROUP CO., LTD., Beijing (CN); FOUNDER INFORMATION INDUSTRY HOLDINGS CO., LTD., Beijing (CN); FOUNDER APABI TECHNOLOGY LIMITED, Beijing (CN)

(21) Appl. No.: 14/104,400

(22) Filed: Dec. 12, 2013

(30) Foreign Application Priority Data
Aug. 8, 2013 (CN) CN201310344315.3

(51) Int. Cl. G06F 17/21

(52) U.S. Cl. CPC G06F 17/211
USPC 715/249

(57) ABSTRACT

Document format processing apparatus and document format processing method are provided. The apparatus comprising: an obtaining unit for obtaining element information of a document in a first format; a parsing unit, for parsing the element information to get source data information; a conversion unit for converting the source data information to target data information of the document in a second format; a document processing unit for processing the target data information. Thus, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

### CROSS-REFERENCE TO RELATED APPLICATIONS

This application claims priority to Chinese Patent Application No. 201310344315.3, filed on Aug. 8, 2013 and entitled “DOCUMENT FORMAT PROCESSING APPARATUS AND DOCUMENT FORMAT PROCESSING METHOD”, which is incorporated herein by reference in its entirety.

### FIELD OF THE INVENTION

The present invention relates to the field of computer techniques, and more particular, to a document format processing apparatus and document format processing method.

### BACKGROUND OF THE INVENTION

With the population of computers, paperless office has gained more and more applications. Users are confronted with a plenty of various documents. In addition to varied types of documents, documents in the same format are continuously upgrading, wherein documents are files stored in computers in the form of data, also called as electronic documents. Information stored in documents, such as text, image, is referred to as document content.

When a document is encoded on a computer, generally, it must be edited and saved according to a certain format, which is called as a document format. Currently, common document formats comprise: Word, OFD (Open Fixed layout Document), PDF (Portable Document Format), CEBX (Common e-Document of Blending XML), XML (Extensible Markup Language). In general, when a document is manipulated in a document processing editor, document content must be parsed at first according to its document format, after which corresponding functional operations may be performed on the document content going through the parsing. Due to different versions of a document format, each document processing editor may only process documents in a specific version of a particular format. Thus, how to make a corresponding document processing editor capable of operating documents in different formats is worth studying. With the development of digital publishing techniques, e-document formats are continuously upgrading, how to make a existing incapable document processing editor support new document formats with minimal costs is also a topic to be researched.

In order to solve the above technical problems, the following methods are adopted in related techniques.

I. Develop complete parsing, display and editing functions for a new version of a document format based on an existing document processing editor's framework and its underlying parsing and rendering engines, and then integrate into the document processing editor and a product supporting the new version. This method has advantages of: better module independency, full support for various features of a new document format, however with shortcomings of: a large amount of computations and higher complexity in implementation.

II. Provide a format conversion tool for converting a new version of a document format to a version of the document format that is supported by the document processing editor. This method has the advantages of: almost not necessary to modify the existing document processing editor, however with a problem of taking additional cost for the conversion tool, as well as longer document conversion time.

### SUMMARY OF THE INVENTION

In view of the above technical problems in related techniques, a technical problem to be addressed in this invention is to provide a technique of realizing compatibility between different document formats to solve the problem of high complexity, or time consuming or high cost in realizing the compatibility between different document formats.

Thus, according to an aspect of this invention, a document format processing apparatus is provided, comprising: an obtaining unit for obtaining element information of a document to be processed in a first format; a parsing unit, for parsing the element information to get source data information; a conversion unit, for converting the source data information to target data information of the document to be processed in a second format; a document processing unit, for processing the target data information.

In this invention, element information of a document to be processed in a first format is obtained and parsed to get source data information contained therein; then the source data information is converted into target data information of the document to be processed in a second format to process the target data information. Thereby, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

According to another aspect of this invention, a document format processing method is further provided, comprising: obtaining element information of a document to be processed in a first format, and parsing the element information to get source data information; converting the source data information to target data information of the document to be processed in a second format; processing the target data information.

In this invention, element information of a document to be processed in a first format is obtained and parsed to get source data information contained therein; then the source data information is converted into target data information of the document to be processed in a second format to process the target data information. Thereby, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

### BRIEF DESCRIPTION OF THE DRAWINGS

FIG. 1 shows a block diagram of a document format processing apparatus according to an embodiment of this invention;

FIG. 2 shows a flowchart of a document format processing method according to an embodiment of this invention;

FIG. 3 shows a flowchart of a format process performed on an OFD document according to another embodiment of this invention;

FIG. 4A shows a schematic diagram of element information of an OFD document according to the embodiment of this invention;

FIG. 4B shows a schematic diagram of element information of a CEBX document according to the embodiment of this invention;

FIG. 5 shows a flowchart of a format process performed on a HTML document according to an embodiment of this invention;

FIG. 6 shows a flowchart of a document format processing method according to another embodiment of this invention.

### DETAILED DESCRIPTION OF THE EMBODIMENTS

For a more distinct understanding of the above objects, features and advantageous of this invention, it will be described in a further detail with reference to drawings and particular embodiments below. It should be noticed that, in the case of no conflicts, embodiments and features of embodiments of this invention may be combined with each other.

Many details will be set forth in the following description to achieve a throughout understanding of this invention, however, this invention may be implemented in other ways different from that disclosed herein, and therefore is not limited to the particular embodiments disclosed below.

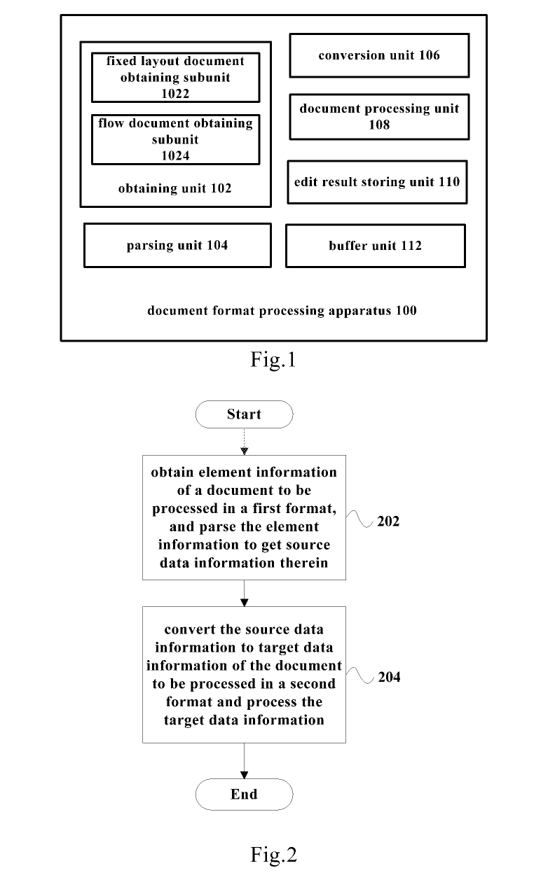

FIG. 1 shows a block diagram of a document format processing apparatus according to an embodiment of this invention.

As shown in FIG. 1, a document format processing apparatus 100 according to an embodiment of this invention comprises: an obtaining unit 102, for obtaining element information of a document to be processed in a first format; a parsing unit 104, for parsing the element information to get source data information; a conversion unit 106, for converting the source data information to target data information of the document to be processed in a second format; and a document processing unit 108, for processing the target data information.

Element information of a document to be processed in a first format is obtained and parsed to get source data information contained therein; then the source data information is converted into target data information of the document to be processed in a second format to process the target data information. Thereby, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

Preferably, the obtaining unit 102 obtains element information of a document to be processed in a first format through executing a message response function. Particularly, a message redirection or recall mechanism is provided, and a message response function is defined in a plug-in module. Then, element information of the document to be processed in the first format is obtained using the message response function; or element information of the document to be processed in the first format is determined through receiving messages returned by other tool (for example, a document processing editor), wherein element information of the document to be processed in the first format is comprised in the received messages.

In any of above technique, preferably, the obtaining unit 102 may comprise a fixed layout document obtaining subunit 1022 and a flow document obtaining subunit 1024. The fixed layout document obtaining subunit 1022 is used to, when the first format of the document to be processed is a fixed layout format, directly obtain element information of the document to be processed in the first format; the flow document obtaining subunit 1024 is used to, when the first format of the document to be processed is a flow format, perform typesetting and pre-paging on the document to be processed, and then obtain element information of the document to be processed in the first format based on the typesetting and pre-paging result.

Because of different typography methods of a document to be processed, element information of the document to be processed in a first format may be obtained in different ways. For example, when the document to be processed is a fixed layout document, typesetting and pre-paging have to be performed on the document to be processed, after which element information of the document to be processed in the first format is obtained based on the typesetting and pre-paging result.

Among other things, typography is a process in which locations and sizes of visual elements, such as text, pictures, graphs, are adjusted on a page layout to make it organized. Among methods of layout presentation for reading, flow layout and fixed layout schemes are two different typographical methods for reading. The major difference of the fixed layout scheme from the flow layout scheme is that its layout is fixed, i.e., an original layout is displayed throughout reading, and no typesetting is performed according to page width after scaling, for example, PDF files created by scanning original pictures, and other text and graphs PDF files created with a fixed layout format, and plain text files.

The flow layout scheme, relative to the fixed layout scheme, refers to storing logic structure information of text, numbers, forms and images in a document without specific typesetting. Contents that are stored are original primitives. Users may check a page after typesetting with a reader, and may realize page width adaptive display at different scaling ratios. On a eBook reader with a small screen, reflow of an original layout is preferred after scaling up to adjust word wrap for paragraphs based on the width of the screen, so as to fit the field of view of a single page.

In any above technical solution, preferably, the conversion unit 106, when the apparatus 100 comprises an editor interface, directly converts source data information to target data information through the editor interface; and when the apparatus 100 does not comprise an editor interface, first, generates target element information based on the source data information, and then parses target data information contained in the target element information. Thus, in the case of providing an editor interface, data conversion may be realized without modifying the original editor interface.

In any above technical solution, preferably, the document format processing apparatus 100 may further comprise: an edit result storing unit 110, for in the process of converting the source data information to target data information of the document to be processed in a second format, recording correspondences between generated target data information and source data information; modifying source data information corresponding to edited target data information according to the correspondences, and storing the modified source data information and the modified document to be processed in the first format.

In any above technical solution, preferably, the document format processing apparatus 100 may further comprise: a buffer unit 112, for after parsing the source data information contained in the element information, and before converting the source data information to target data information of the document to be processed in the second format, buffering the source data information; when a process request message is received, converting the source data information to target data information of the document to be processed in the second format.

After the parsing of source data information contained in the element information, the source data information may be processed immediately, or may be buffered. If it is determined that the document to be processed in the first format has not been changed when a process request message is received, the buffered source data information is converted to target data information. If it is determined that the document to be processed in the first format has been changed when a process request message is received, element information of the document to be processed is obtained and then is parsed to obtain source data information contained in the obtained element information again, after which source data information obtained through parsing is converted to target data information.

In any above technical solution, preferably, the source data information of the document to be processed in the first format and the target data information of the document in the second format comprise: basic information and/or page data, wherein the basic information comprises at least one or a combination of: metadata, outline data and cover data; the page data comprises at least one or a combination of: text, numbers, forms, images and audios/videos.

Obtaining element information of the document to be processed in the first format in different ways depending on different typography schemes mentioned above particularly comprises obtaining page data in different ways, and obtaining basic information in the same manner. That is to say, when the document's typography scheme is the flow layout scheme, when basic information is obtained, it may obtained directly without typesetting and pre-paging of the document to be processed. However, when page data is obtained, typesetting and pre-paging have to be performed on the document to be processed, after which corresponding page data may be obtained from the processed document.

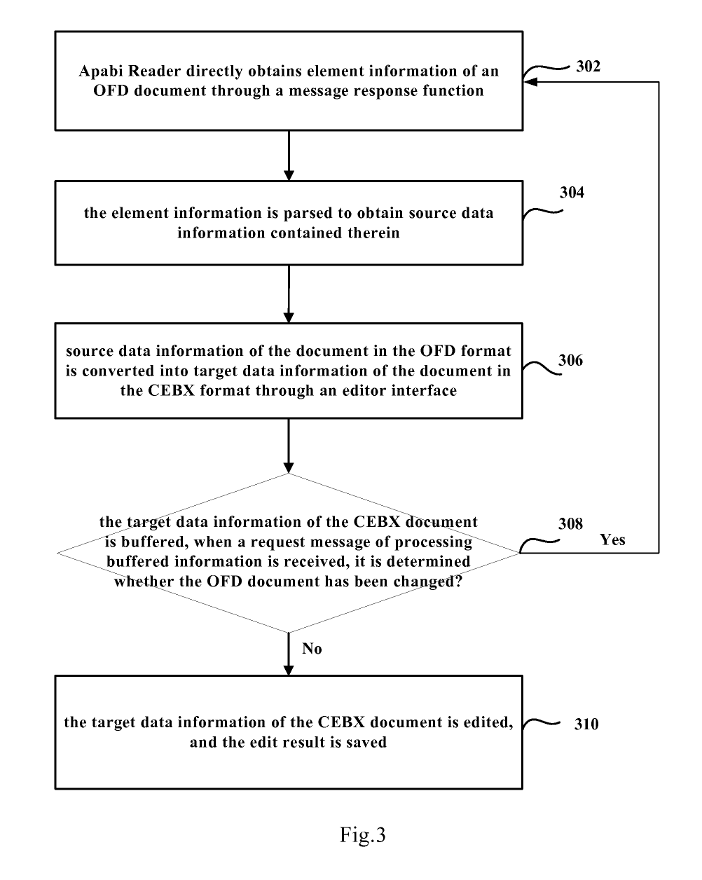

FIG. 2 shows a flowchart of a document format processing method according to an embodiment of this invention.

As shown in FIG. 2, a document format processing method may comprise the following technical solution: at step 202, obtaining element information of a document to be processed in a first format, and parsing the element information to get source data information; at step 204, converting the source data information to target data information of the document to be processed in a second format and processing the target data information.

Element information of a document to be processed in a first format is obtained and parsed to get source data information contained therein; then the source data information is converted into target data information of the document to be processed in a second format to process the target data information. Thereby, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

In any above technical solution, preferably, element information of a document to be processed in a first format is obtained through executing a message response function. Particularly, a message redirection or recall mechanism is provided, and a message response function is defined in a plug-in module. Then, element information of the document to be processed in the first format is obtained using the message response function; or element information of the document to be processed in the first format is determined through receiving messages returned by other tool (for example, a document processing editor), wherein element information of the document to be processed in the first format is comprised in the received messages.

Preferably, the step of obtaining element information of a document to be processed in a first format comprises: if the first format of the document to be processed is a fixed layout format, directly obtaining element information of the document to be processed in the first format; if the first format of the document to be processed is a flow format, performing typesetting and pre-paging on the document to be processed, and then obtaining element information of the document to be processed in the first format based on the typesetting and pre-paging result.

Because of different typography methods of a document to be processed, element information of the document to be processed in a first format may be obtained in different ways. For example, when the document to be processed is a fixed layout document, typesetting and pre-paging have to be performed on the document to be processed, after which element information of the document to be processed in the first format is obtained based on the typesetting and pre-paging result.

Among other things, typography is a process in which locations and sizes of visual elements, such as text, pictures, graphs, are adjusted on a page layout to make it organized. Among methods of layout presentation for reading, flow layout and fixed layout schemes are two different typographical methods for reading. The major difference of the fixed layout scheme from the flow layout scheme is that its layout is fixed, i.e., an original layout is displayed throughout reading, and no typesetting is performed according to page width after scaling, for example, PDF files created by scanning original pictures, and other text and graphs PDF files created with a fixed layout format, and plain text files.

The flow layout scheme, relative to the fixed layout scheme, refers to storing logic structure information of text, numbers, forms and images in a document without specific typesetting. Contents that are stored are original primitives. Users may check a page after typesetting with a reader, and may realize page width adaptive display at different scaling ratios. On a eBook reader with a small screen, reflow of an original layout is preferred after scaling up to adjust word wrap for paragraphs based on the width of the screen, so as to fit the field of view of a single page.

In any above technical solution, preferably, the step of converting the source data information to target data information of the document to be processed in a second format comprises: if there is an editor interface provided, directly converting source data information to target data information through the editor interface; and if there is not an editor interface provided, generating target element information based on the source data information, and then parsing target data information contained in the target element information.

In any above technical solution, preferably, the following step may be further comprised: if it is supported to edit and store edit results, in the process of converting the source data information to target data information of the document to be processed in a second format, recording correspondences between generated target data information and source data information; modifying source data information corresponding to edited target data information according to the correspondences, and storing the modified source data information and the modified document to be processed in the first format.

In any above technical solution, preferably, after the parsing of source data information contained in the element information, and before converting the source data information to target data information of the document to be processed in the second format, the source data information is buffered; when a process request message is received, converting the source data information to target data information of the document to be processed in the second format.

After the parsing of source data information contained in the element information, the source data information may be processed immediately, or may be buffered. If it is determined that the document to be processed in the first format has not been changed when a process request message is received, the buffered source data information is converted to target data information. If it is determined that the document to be processed in the first format has been changed when a process request message is received, element information of the document to be processed is obtained and then is parsed to obtain source data information contained in the obtained element information again, after which source data information obtained through parsing is converted to target data information.

In any above technical solution, preferably, the source data information of the document to be processed in the first format and the target data information of the document in the second format comprise: basic information and/or page data, wherein the basic information comprises at least one or a combination of: metadata, outline data, cover data; the page data comprises at least one or a combination of: text, numbers, forms, images, audios/videos.

Obtaining element information of the document to be processed in the first format in different ways depending on different typography schemes mentioned above particularly comprises obtaining page data in different ways, and obtaining basic information in the same manner. That is to say, when the document's typography scheme is the flow layout scheme, when basic information is obtained, it may obtained directly without typesetting and pre-paging of the document to be processed. However, when page data is obtained, typesetting and pre-paging have to be performed on the document to be processed, after which corresponding page data may be obtained from the processed document.

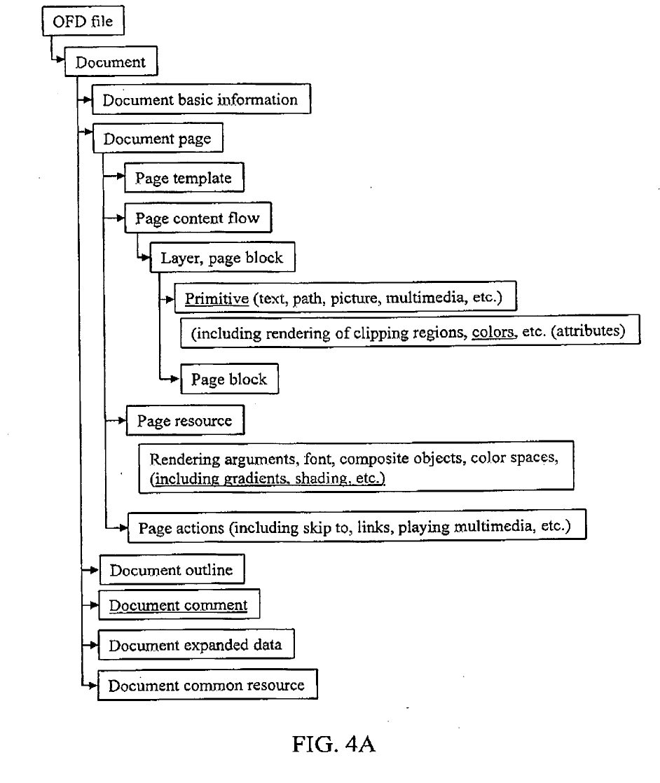

For a better understanding of embodiments of this invention, a particular application scenario is given below (refer to FIG. 3 to FIG. 5), directed to a process of realizing compatibility between different document formats, as described in detail as follows.

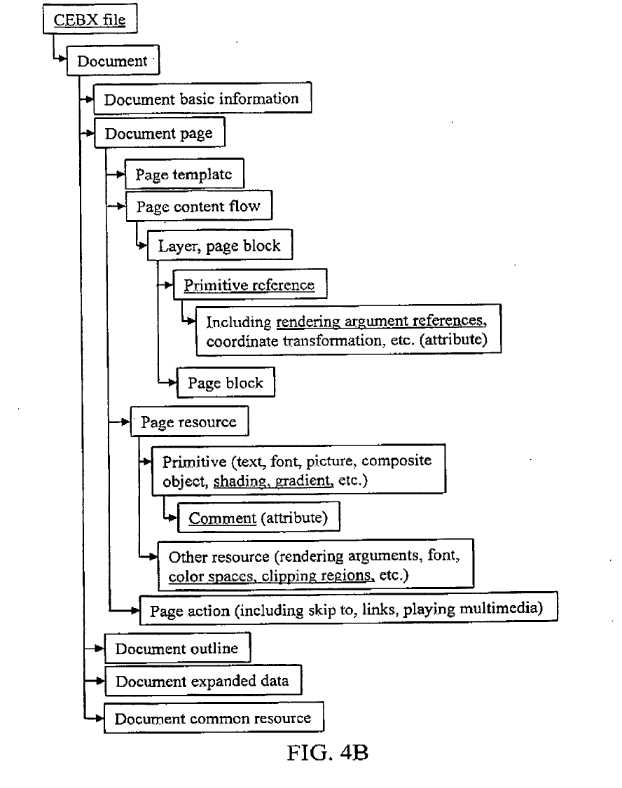

The document processing editor is Apabi Reader, and the document to be processed is an OFD document, wherein element information of the OFD document is shown in the schematic diagram of FIG. 4A.

Apabi Reader is a reader for multiple types of documents, such as ebooks, electronic official documents, electronic newspapers, and electronic magazines, and may support the parsing and displaying of CEBX, PDF, ePub fixed layout document formats, provide simple editing functions such as document comment. Wherein, element information of a CEBX document is shown in the schematic diagram of FIG. 4B.

OFD is a national standard under application of a fixed layout document format drafted by the electronic files storage and exchange formats—Fixed layout document standard work group.

In order to support the display of OFD documents and rapidly accommodate changes in the development and improvement of the OFD specification, Apabi Reader depends on parsing, display and editing methods of CEBX documents, which are realized in the solution provided in this invention and comprise the following steps (referring to FIG. 3).

At step 302, Apabi Reader directly obtains element information of an OFD document through a message response function.

At this step, when an OFD document is opened, Apabi Reader may invoke a message response function of a plug-in module to obtain element information of the OFD document, or may invoke a message response function of a plug-in module when obtaining page data corresponding to a page of the OFD document to obtain element information of the OFD document.

At step 304, the element information is parsed to obtain source data information contained therein.

At this step, source data information contained in the element information that is parsed at least comprises basic information and page data, wherein the basic information comprises at least: metadata, outline data, cover data.

At step 306, source data information of the document in the OFD format is converted into target data information of the document in the CEBX format through an editor interface.

At this step, the source data information is converted into target data information of the OFD document in the CEBX format, and correspondences between the target data information and the source data information are recorded in the conversion process, wherein the target data information comprises at least: basic information and page data.

At step 308, the target data information of the CEBX document is buffered, when a request message of processing buffered information is received, it is determined whether the OFD document has been changed, if Yes, the process proceeds to step 302; otherwise, it proceeds to step 310.

At step 310, the target data information of the CEBX document is edited, and the edit result is saved.

At this step, comments are added to pages of the CEBX document after conversion. Because correspondences between the target data information and the source data information are recorded at step 306, commends on the CEBX document may be converted into commends on the OFD document based on the correspondences, and then may be saved in the OFD document.

FIG. 4A and FIG. 4B are schematic diagrams of objects and hierarchical relationships between the OFD and CEBX layout document formats respectively. It can be seen that both formats have substantially the same basic information and page data representations, in most cases, source data information obtained through parsing the OFD document may be directly added as element information of the CEBX document after appropriate conversion. Certainly, there are differences between the above two document formats, particularly as follows.

OFD and CEBX documents define primitives in different ways: in an OFD document, primitives directly represent visible units on a page, such as text, paths, pictures, and multimedia, while in a CEBX document, primitives are defined as resources saved in a resource file, and only references to primitives are present on pages. A primitive may be referenced by a resource ID, for which coordinate transformation and rendering reference arguments are provided further. Thus, in the above embodiment, for the conversion to page data of target data information of the CEBX document, OFD primitive objects must be separated from their rending parameters, coordinate transformations and other attributes to generate CEBX primitives and primitive references correspondingly.

OFD and CEBX documents have different definitions of gradient shading. In an OFD document, gradient shading is defined as a complex colour space, and may be used as a fill colour rending argument for a primitive. In a CEBX document, gradient and shading are also defined as regular primitives with effective rendering areas which may be controlled by clipping regions. Thus, in the above embodiment, for the conversion of page data of target data information of the CEBX document, shading or gradient objects corresponding to the CEBX document must be created according to primitives with expanded fill colours, and then the original primitives to be filled may be converted and added as clipping regions of the objects.

OFD and CEBX documents have different comment object definitions. In an OFD document, comment objects are separately defined at the document layer, with pages on which they are present and their correlated primitive objects recorded as well. In a CEBX document, a comment object is defined as an attribute of a primitive object. Thus, in the above embodiment, for the conversion of page data of target data information of the CEBX document, pages on which each comment is present and its correlated primitive object must be recorded through parsing in advance, and then comment attributes may be searched and added when primitive objects of the CEBX document are added.

Further, for those representations of OFD documents that cannot be represented by CEBX documents, a flattening approximation strategy may be adopted to convert representations of OFD documents to their approximate representations or directly output as pictures and thereby guarantee display effects.

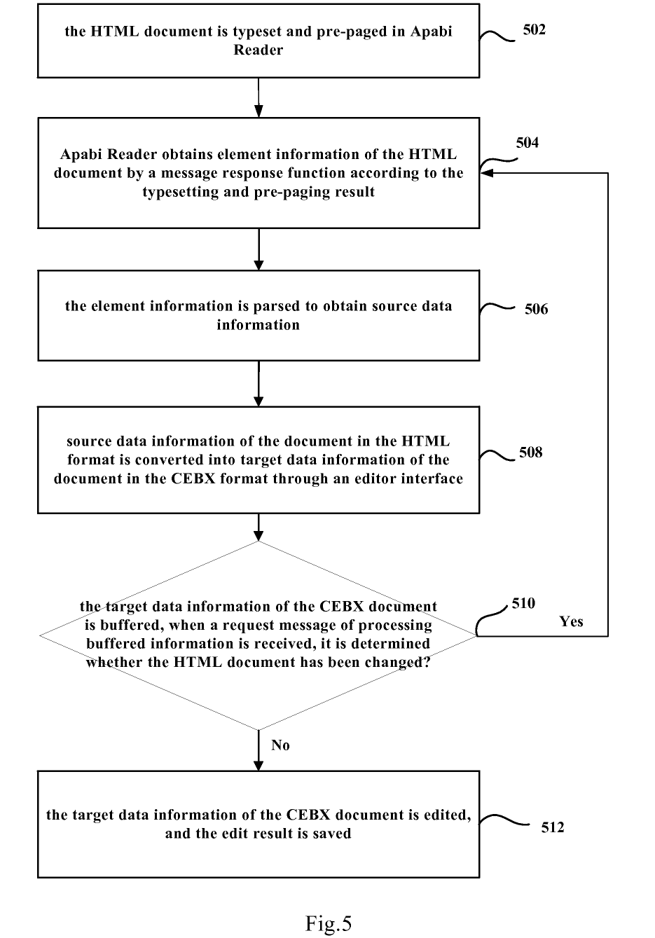

Referring to FIG. 5, in this embodiment, the document processing editor is Apabi Reader and the document to be processed is a HTML document.

At step 502, the HTML document is typeset and pre-paged in Apabi Reader.

At this step, when the HTML document is opened, Apabi Reader may invoke a message response function of a plug-in module to obtain element information of the HTML document, or may invoke a message response function of a plug-in module when obtaining page data corresponding to a page of the HTML document to obtain element information of the HTML document.

At step 504, Apabi Reader obtains element information of the HTML document by a message response function according to the typesetting and pre-paging result.

At this step, Apabi Reader records a total page number and starting and ending flow locations of each page according to the typesetting and pre-paging result, and then data between starting and ending flow locations of a page is extracted to obtain element information of the HTML document.

At step 506, the element information is parsed to obtain source data information.

At this step, the element information is parsed to obtain source data information, at least comprising: basic information and page data, wherein the basic information comprises at least: metadata, outline data, cover data.

At step 508, source data information of the document in the HTML format is converted into target data information of the document in the CEBX format through an editor interface.

At this step, the source data information is converted into target data information of the HTML document in the CEBX format, and correspondences between the target data information and the source data information are recorded in the conversion process, wherein the target data information comprises at least: basic information and page data.

At step 510, the target data information of the CEBX document is buffered, when a request message of processing buffered information is received, it is determined whether the HTML document has been changed, if Yes, the process proceeds to step 502; otherwise, it proceeds to step 512.

At step 512, the target data information of the CEBX document is edited, and the edit result is saved.

At this step, if comments are added for pages of the CEBX document after conversion. Because correspondences between the target data information and the source data information are recorded at step 508, commends on the CEBX document may be converted into commends on the HTML document based on the correspondences, and then may be saved in the HTML document.

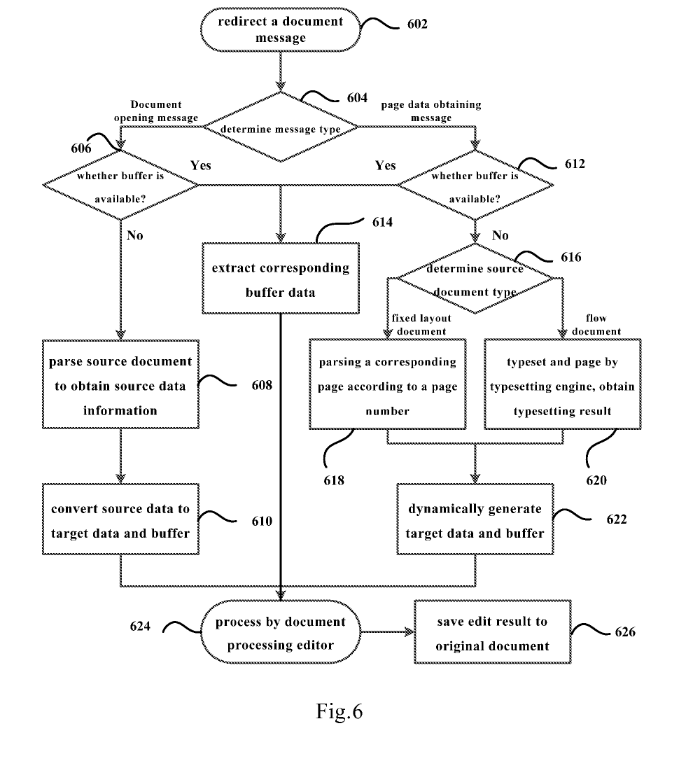

Below, the technical solution of this invention will be further described with reference to FIG. 6.

As shown in FIG. 6, at step 602, on the basis of existing fixed layout document processing software (Apabi Reader), through the support of an external plug-in, when a document in a new format that is not supported in opened, or when page data of a page of a document in a new format that is not supported is obtained, a response function registered in the plug-in is invoked to redirect a document message.

At step 604, the type of the message is determined; when the message type is a document opening message, step 606 is executed, and when the message type is a page data obtaining message, step 612 is executed.

At step 606, it is detected whether there is document data in the buffer; if Yes, step 614 is executed; otherwise, step 608 is executed.

At step 608, the source document is parsed to obtain source data information. At step 610, source data information is converted to TTDD and then is buffered, and correspondences between target data information and source data information are recorded.

At step 624, target data information is processed by the document processing editor. At step 626, an edit result is saved in the original document.

At step 612, when it is determined that the message type is a page data obtaining message, it is determined whether there is available data in the buffer; if Yes, the step 614 is executed to process extracted buffer data by the document processing editor; otherwise, step 616 is executed.

At step 616, the type of the source document is determined. When the source document is a flow layout document, step 620 is executed; when the source document is a fixed layout document, step 628 is executed.

At step 620, typesetting and paging are performed by a typesetting engine to obtain a typesetting result. At step 618, a corresponding page is parsed according to a page number. At step 622, target data of the corresponding page is generated and buffered according to source data of a corresponding page, and then steps 624 and step 626 are executed.

Note that, when the document processing editor obtains a total page number or a page's messages for the first time, a source document in a new format is opened, document data parsing and typesetting/pre-paging operations are carried out according to predetermined typesetting parameters, and a total page number and starting and ending flow locations of various pages are recorded.

For the acquisition of page data, according to the parsing and typesetting/pre-paging result, data between corresponding starting and ending flow locations of a page is extracted and re-typeset to dynamically generate target page data.

The parsing and typesetting/pre-paging operations need to scan and process the whole document, and thereby may need a longer pre-process time. For a better reading experience, a client may consider displaying a progress bar when a document is opened for the first time, or performing a pre-processing or buffering operation in advance. By virtue of the strategy of dynamically parsing and dynamical generating based on pages, in conjunction with a page data buffering strategy, the document pre-processing method requires much less time than the document conversion method, and thus a better user experience may be obtained.

In summary, element information of a document to be processed in a first format is obtained and parsed to get source data information contained therein; then the source data information is converted into target data information of the document to be processed in a second format to process the target data information. Thereby, when a document in an unsupported format is processed, what is only needed is to convert the format of source data contained in the document to a target data format, rather than thoroughly developing of the existing document processing editor, and thus complexity may be reduced; meanwhile, because it is not necessary to convert a document format using other format conversion tool, implementation cost and time consumed may be reduced.

One skilled in the art should understand that, the embodiments of this application may be provided as a method, a system, or a computer program product. Therefore, this application may be in the form of full hardware embodiments, full software embodiments, or a combination thereof. Moreover, this application may be in the form of a computer program product that is implemented on one or more computer-usable storage media (including, without limitation, magnetic disk storage, CD-ROM and optical storage) containing computer-usable program codes.

This application is described referring to the flow chart and/or block diagram of the method, device (system) and computer program product according to the embodiments of this application. It should be understood that, each flow and/or block in the flow chart and/or block diagram and the combination of flow and/or block in the flow chart and/or block diagram may be realized via computer program instructions. Such computer program instructions may be provided to the processor of a general-purpose computer, special-purpose computer, a built-in processor or other programmable data processing devices, to produce a machine, so that the instructions executed by the processor of a computer or other programmable data processing devices may produce a device for realizing the functions specified in one or more flows in the flow chart and/or one or more blocks in the block diagram.

Such computer program instructions may also be stored in a computer-readable storage that can guide a computer or other programmable data processing devices to work in a specific mode, so that the instructions stored in the computer-readable storage may produce a manufacture including a commander equipment, wherein the commander equipment may realize the functions specified in one or more flows of the flow chart and one or more blocks in the block diagram.

Such computer program instructions may also be loaded to a computer or other programmable data processing devices, so that a series of operational processes may be executed on the computer or other programmable devices to produce a computer-realized processing, thereby the instructions executed on the computer or other programmable devices may provide a process for realizing the functions specified in one or more flows in the flow chart and/or one or more blocks in the block diagram.

Although preferred embodiments of this application have been described above, other variations and modifications can be made by one skilled in the art in the teaching of the basic creative conception. Therefore, the preferred embodiments and all these variations and modifications are intended to be contemplated by the appended claims.

What are described above are merely preferred embodiments of the present invention, but do not limit the protection scope of the present invention. Various modifications or variations can be made to this invention by persons skilled in the art. Any modifications, substitutions, and improvements within the scope and spirit of this invention should be encompassed in the protection scope of this invention.

What is claimed is:

1. A document format processing apparatus, characterized in comprising:
an obtaining unit for obtaining element information of a document to be processed in a first format;
a parsing unit for parsing the element information to get source data information;
a conversion unit for converting the source data information to target data information of the document to be processed in a second format;
a document processing unit, for processing the target data information.

2. The apparatus of claim 1 wherein the obtaining unit comprises a fixed layout document obtaining subunit and a flow document obtaining subunit,
wherein the fixed layout document obtaining subunit is used to, when the first format of the document to be processed is a fixed layout format, directly obtain element information of the document to be processed in the first format;
the flow document obtaining subunit is used to, when the first format of the document to be processed is a flow format, perform typesetting and pre-paging on the document to be processed, and then obtain element information of the document to be processed in the first format based on the typesetting and pre-paging result.

3. The apparatus of claim 1 wherein when the apparatus comprises an editor interface, the conversion unit directly converts source data information to target data information through the editor interface; and when the apparatus does not comprise an editor interface, the conversion unit first generates target element information based on the source data information, and then parses the target element information to obtain target data information contained therein.

4. The apparatus of claim 1 wherein the obtaining unit obtains element information of a document to be processed in a first format through executing a message response function; or element information of the document to be processed in the first format is determined through receiving messages returned by other tool, wherein element information of the document to be processed in the first format is comprised in the received messages.

5. The apparatus of claim 1 further comprising:
an edit result storing unit, for in the process of converting the source data information to target data information of the document to be processed in a second format, recording correspondences between generated target data information and source data information, modifying source data information corresponding to edited target data information according to the correspondences, and storing the modified source data information.

6. The apparatus of claim 1 further comprising:
a buffer unit, for after parsing the source data information contained in the element information, and before converting the source data information to target data information of the document to be processed in the second format, buffering the source data information; when a process request message is received, converting the source data information to target data information of the document to be processed in the second format.

7. The apparatus of claim 1 wherein the source data information of the document to be processed in the first format and the target data information of the document in the second format comprise: basic information and/or page data, wherein the basic information comprises at least one or a combination of: metadata, outline data and cover data; the page data comprises at least one or a combination of: text, numbers, forms, images and audios/videos.

8. A document format processing method comprising:
obtaining element information of a document to be processed in a first format, and parsing the element information to get source data information contained therein; and
converting the source data information to target data information of the document to be processed in a second format, and processing the target data information.

9. The method of claim 8 wherein obtaining element information of a document to be processed in a first format comprises:
if the first format of the document to be processed is a fixed layout format, directly obtaining element information of the document to be processed in the first format;
if the first format of the document to be processed is a flow format, performing typesetting and pre-paging on the document to be processed, and then obtaining element information of the document to be processed in the first format based on the typesetting and pre-paging result.

10. The method of claim 8 wherein converting the source data information to target data information of the document to be processed in a second format comprises:
if there is an editor interface provided, directly converting source data information to target data information through the editor interface; and
if there is not an editor interface provided, generating target element information based on the source data information, and then parsing the target element information to get target data information contained therein.

11. The method of claim 8 wherein obtaining element information of a document to be processed in a first format comprises:
obtaining element information of a document to be processed in a first format through executing a message response function; or
determining element information of the document to be processed in the first format through receiving messages returned by other tool, wherein element information of the document to be processed in the first format is comprised in the received messages.

12. The method of claim 8 further comprising:
if it is supported to edit and store edit results, in the process of converting the source data information to target data information of the document to be processed in a second format, recording correspondences between generated target data information and source data information; modifying source data information corresponding to edited target data information according to the correspondences, and storing the modified source data information.

13. The method of claim 8 wherein after the parsing the element information to get source data information contained therein, and before converting the source data information to target data information of the document to be processed in the second format, the source data information is buffered; when a process request message is received, converting the source data information to target data information of the document to be processed in the second format.

14. The apparatus of claim 8 wherein the source data information of the document to be processed in the first format and the target data information of the document in the second format comprise: basic information and/or page data, wherein the basic information comprises at least one or a combination of: metadata, outline data and cover data; the page data comprises at least one or a combination of: text, numbers, forms, images and audios/videos.
